(19) United States
(12) Patent Application Publication
(10) Pub. No.: US 2015/0122462 A1
(43) Pub. Date: May 7, 2015

(54) RADIAL BACKFLOW WICK STRUCTURE OF SLIM-TYPE HEAT PIPE AND MANUFACTURING METHOD FOR THE SAME

(71) Applicant: Hao PAI, New Taipei City (TW)

(72) Inventor: Hao PAI, New Taipei City (TW)

(21) Appl. No.: 14/102,263

(22) Filed: Dec. 10, 2013

(30) Foreign Application Priority Data
Nov. 7, 2013 (TW) 102140498

(51) Int. Cl. F28D 15/04; B23P 15/26

(52) U.S. Cl. CPC F28D 15/046; B23P 15/26
USPC 165/104.26; 29/890.032

(57) ABSTRACT

A slim-type heat pipe includes a tube, being hollow and flat; and a wick structure, longitudinally disposed in the tube, having an attachment side attached on a local portion of an inner side of the tube and a formation side opposite to the attachment side, and a vapor passage formed between the formation side and the inner side of the tube. The wick structure is provided with grooves radially around the inner side of the tube. The attachment side is attached on the grooves. Depth of the groove is less than 30% of thickness of a wall of the tube.

### BACKGROUND OF THE INVENTION

1. Technical Field

The invention relates to thermal conductors, particularly to radial backflow wick structure of slim-type heat pipe and manufacturing method for the same.

2. Related Art

Modern electronic devices always tend to be light, thin, short and small in appearance, so heat pipes used in such compact electronic devices must also be miniaturized. As a result, a slim-type heat pipe, whose thickness is less than 1.5 mm, is presented.

However, a wick structure in such a slim-type heat pipe must be thin and narrow, otherwise a gas passage in the heat pipe will not be enough. Besides, the during manufacturing, sintered powder forming the thin wick structure cannot be injected into the gap between the core bar and the tube wall. Such a narrow gap will cause friction to the powder so that the powder is hard to reach a predetermined position. Thus, a typically conventional approach can form the powdered wick structure at a local position of the tube without miniaturization. Additionally, a sufficient vapor passage must be kept. Thus the thin wick structure only extends longitudinally (i.e., axially). It cannot provide radial backflow of the working fluid. As a result, when some working fluid is condensed on the inside of the heat pipe, the particles are too small to immediately flow back to the wick structure. This will cause decrease of heat transfer because of an insufficient amount of the backflow working fluid.

### SUMMARY OF THE INVENTION

The invention is to provide a radial backflow wick structure of slim-type heat pipe and manufacturing method for the same. A thin wick structure is formed in a slim-type heat pipe to provide axial and radial backflow effects to the working fluid, so that the working fluid can be extensively condensed or evaporated by the radial grooves, and then the condensed working fluid can flow back to the wick structure because thermal resistance of condensation or evaporation is reduced. Also, the radial grooves can prevent liquid drops which impede the vapor passage from being formed. This can further reduce thermal resistance in the vapor passage. That is, the thermal resistances in the evaporating section, condensing section and vapor passage can all be reduced.

Accordingly, the heat pipe structure of the invention includes a tube, being hollow and flat; and a wick structure, longitudinally disposed in the tube, having an attachment side attached on a local portion of an inner side of the tube and a formation side opposite to the attachment side, and a vapor passage formed between the formation side and the inner side of the tube. The wick structure is provided with grooves radially around the inner side of the tube. The attachment side is attached on the grooves. Depth of the groove is less than 30% of thickness of a wall of the tube.

Moreover, the method for manufacturing a slim-type heat pipe of the invention includes the steps of:

a) preparing a tube with radial grooves around an inner side thereof;

b) providing a flat wick structure with an attachment side being capable of attaching on a local portion of the inner side of the tube and a formation side opposite to the attachment side;

c) placing the wick structure into the tube to attach the attachment side on the local portion of the inner side of the tube, wherein the wick structure is superposed on the grooves; and

d) flattening the tube to make the inner side of the tube abut against the formation side and to form a vapor passage between the formation side and the inner side of the tube.

### BRIEF DESCRIPTION OF THE DRAWINGS

FIG. 1 is a flowchart of the manufacturing method of the invention;

FIG. 2 is a schematic view of the tube in preparation according to the invention;

FIG. 3 is a schematic view showing the wick structure in the tube;

FIG. 4 is a schematic view showing the wick structure is positioned in the tube by a tool and is sintered;

FIG. 5 is a cross-sectional view of the tube after being flattened;

FIG. 6 is a perspective view of the finished heat pipe according to the invention; and

FIG. 7 is a cross-sectional view of the finished heat pipe according to the invention.

### DETAILED DESCRIPTION OF THE INVENTION

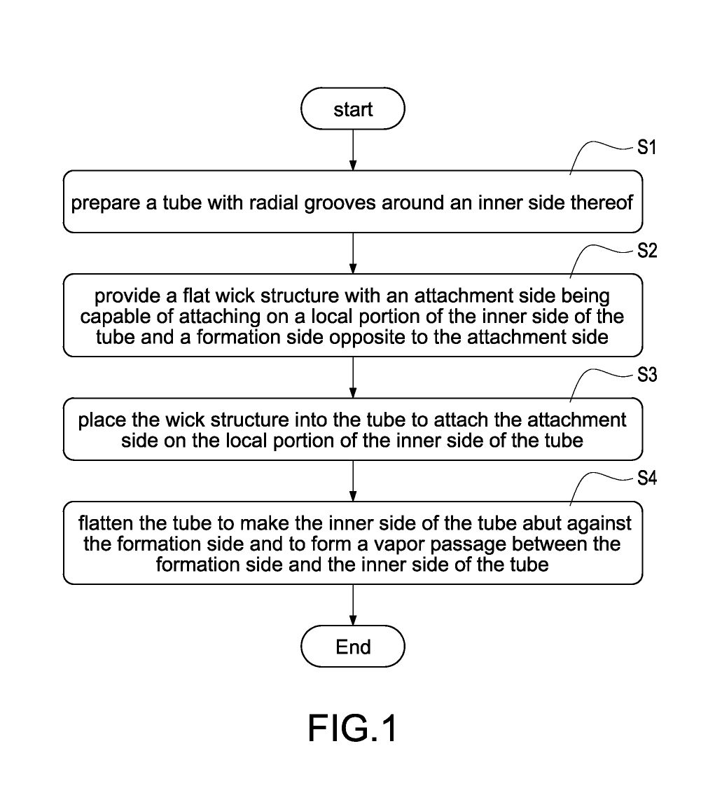

Please refer to FIG. 1. The method for manufacturing a slim-type heat pipe of the invention includes the steps as follows.

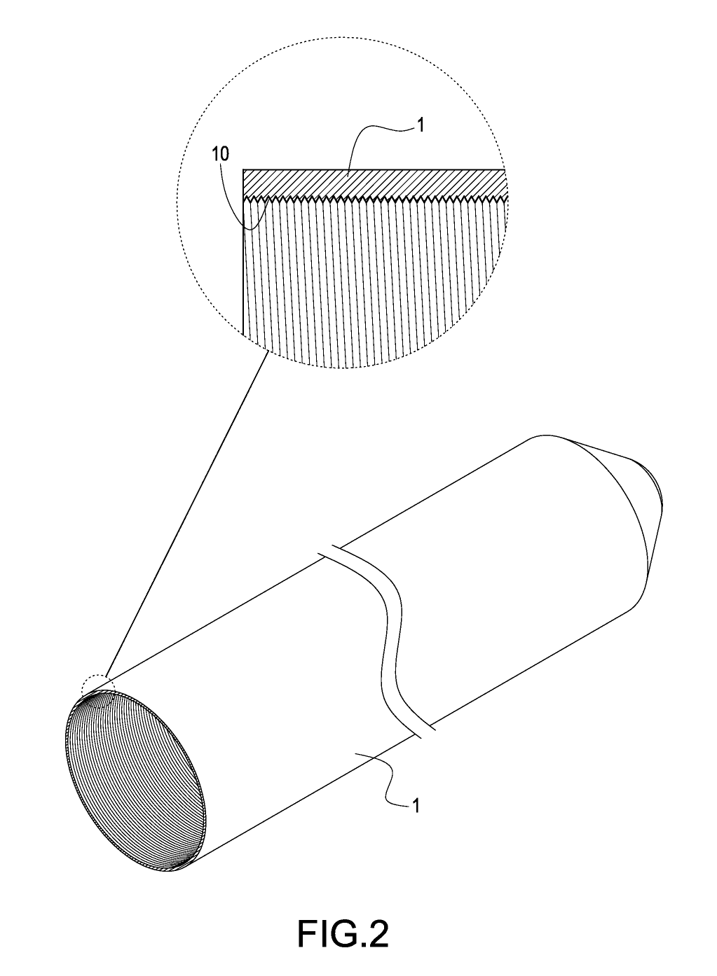

First, in the step S1, as shown in FIG. 2, prepare a tube 1 with radial grooves 10 around an inner side thereof. The grooves 10 may not completely cover the inner side of the tube 1 and may be formed on local areas, for example, the evaporating section and the condensing section. Additionally, the grooves 10 can be formed by surface processing by a tool, surface corrosion or surface etching. The tool may be a knife for pressing or cutting the inner side of the tube. The grooves 10 can also be formed by a grinding surface such as a roller, grinding wheel or sandpaper. The grooves 10 can be concentric, spiral (a left spiral, a right spiral or a combination of left and right spirals) or irregular. The depth of the groove 10 is less than 0.03 mm, and usually the depth of the groove 10 is less than 30% of thickness of the tube wall.

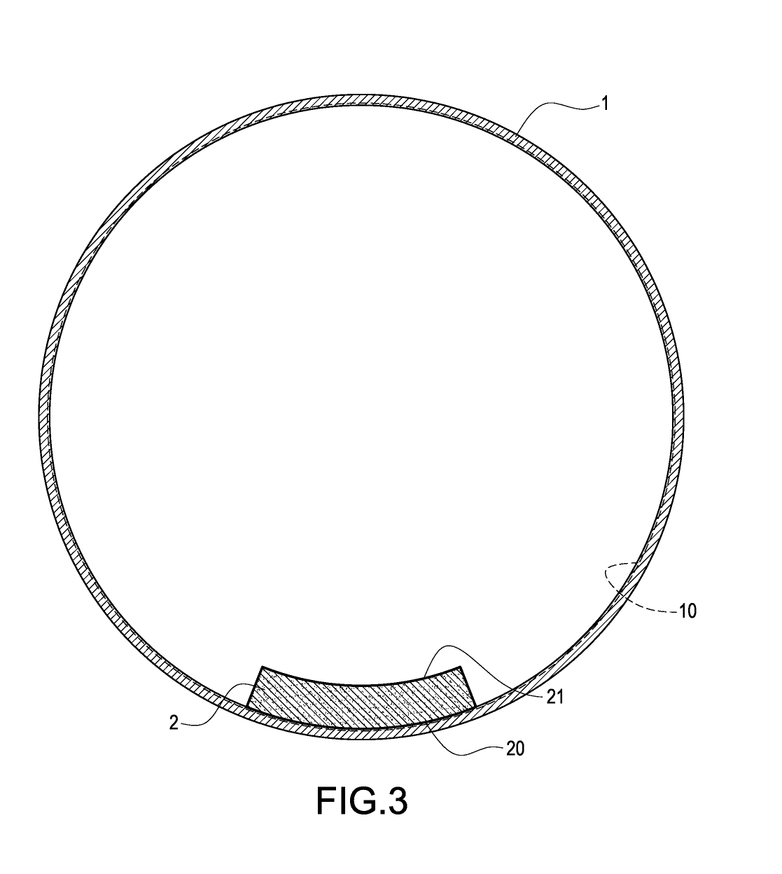

Next, in step S2, as shown in FIG. 3, provide a flat wick structure 2 with an attachment side 20 being capable of attaching on a local portion of the inner side of the tube 1 and a formation side 21 opposite to the attachment side 20. The wick structure 2 can be made by sintering, pressing or weaving and can be fiber, knitting, powder or combination thereof.

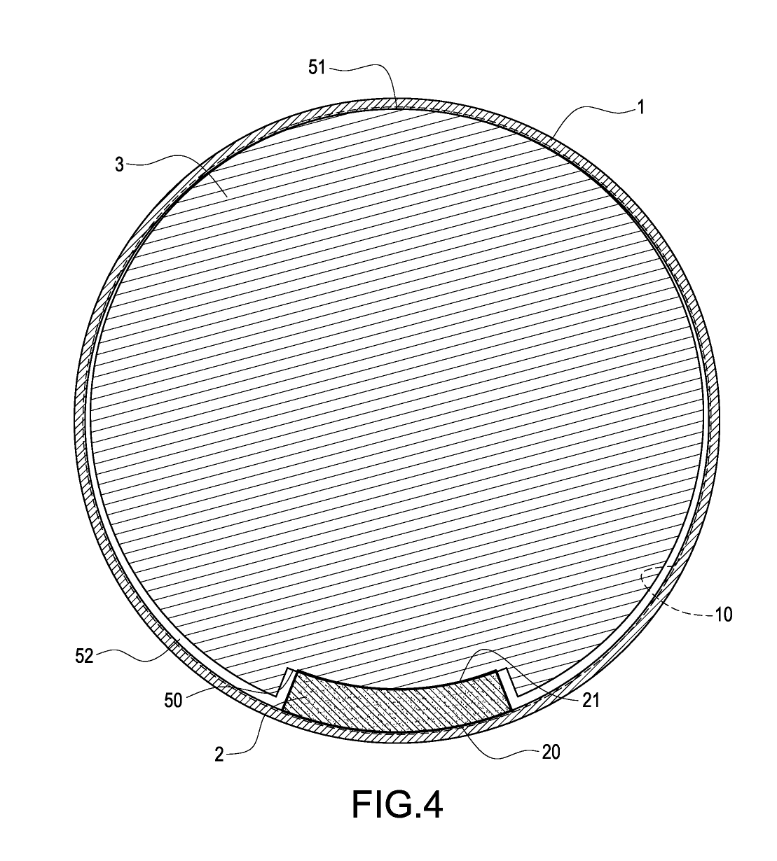

Then, in step S3, as shown in FIG. 3, place the wick structure 2 into the tube 1 to attach the attachment side 20 on the local portion of the inner side of the tube 1, wherein the wick structure 2 is completely or partially superposed on the grooves 10. Please refer to FIG. 4. The wick structure 2 can be positioned by a tool 3. The tool 3 is a rod which can be inserted into the tube 1 and has an aim surface 50 corresponding to the formation side 21 of the wick structure 2 and an abutting portion 51 which is opposite to the aim surface 50 and abuts against the inner side of the tube 1. When the tool 3 has been placed in the tube 1, a gap 52 is remained to reduce friction. After that, the attachment side 20 of the wick structure 2 is attached on the tube wall by sintering.

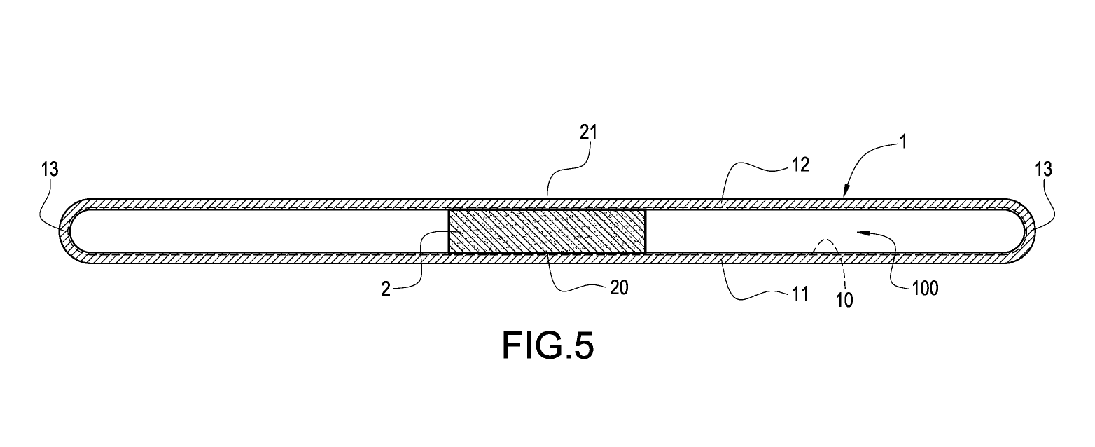

Finally, in step S4, as shown in FIG. 5, flatten the tube 1 to make the inner side of the tube 1 abut against the formation side 21 and to form a vapor passage 100 between the formation side 21 and the inner side of the tube 1. By the above steps, the radial backflow wick structure of slim-type heat pipe can be made. The wick structure 2 can provide a radial backflow effect by the grooves 10.

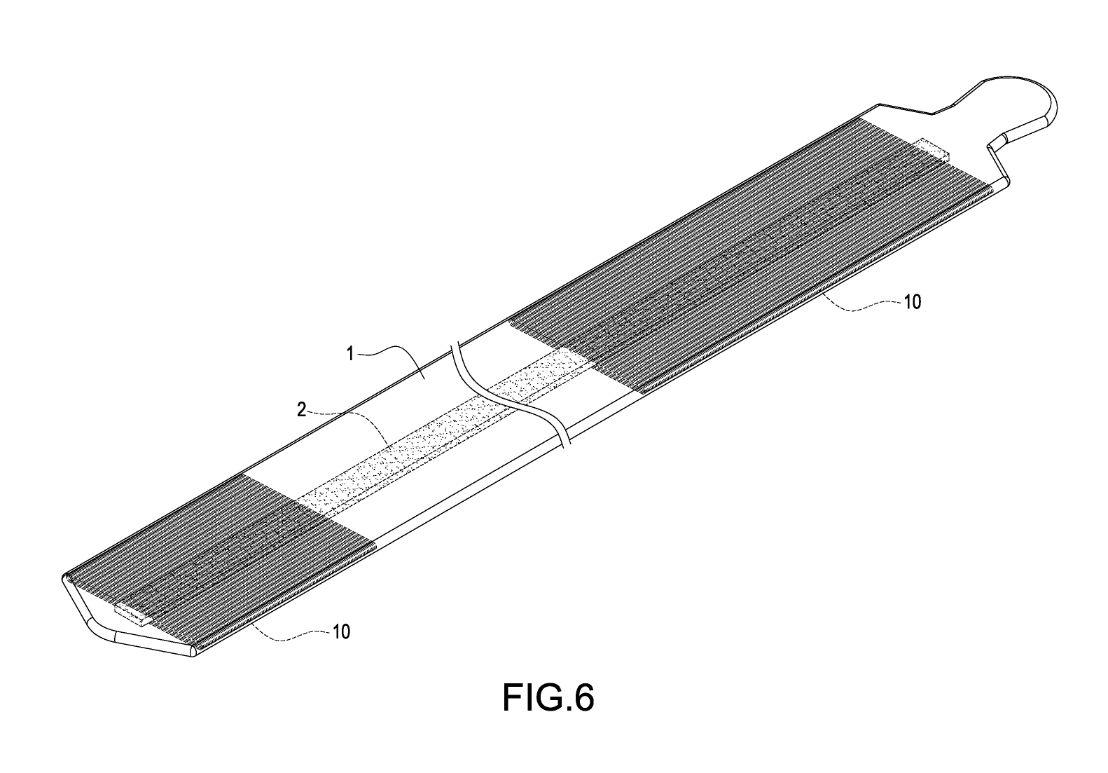

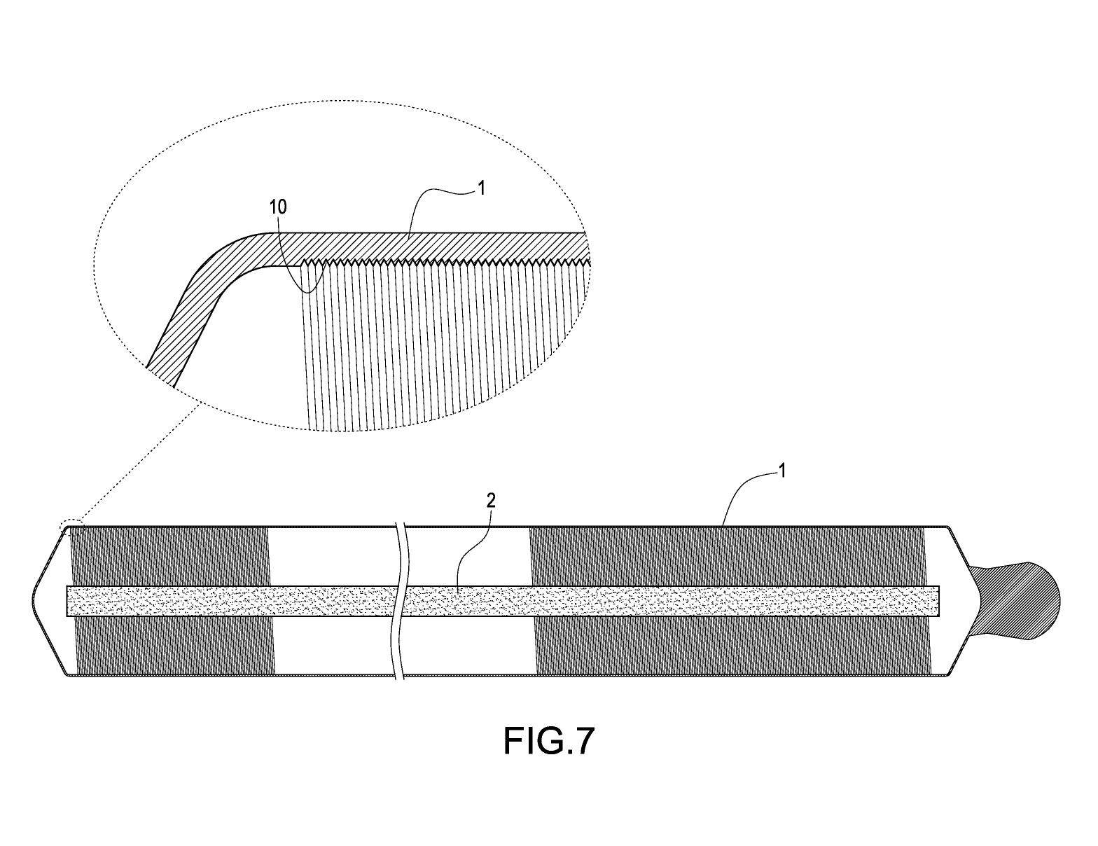

Please refer to FIGS. 6 and 7. The heat pipe includes the flat tube 1 and the wick structure 2 which longitudinally extends. The inner side of the tube 1 is formed with the grooves 10. The outside thickness of the tube 1 is below 0.6 mm. The flattened tube 1 has a lower wall 11, an upper wall 12 and two side walls 13 between the upper wall 12 and lower wall 11. The grooves 10 may be located in the condensing section and evaporating section and superposes the wick structure 2. As shown in FIG. 5, at the portion of the tube 1, where the wick structure 2 superposes the grooves 10, the wick structure 2 can provide an axial (longitudinal) backflow effect to the working fluid, and the grooves 10 also provide a radial backflow effect to the working fluid so that the working fluid congregates in the wick structure 2. The condensed working fluid in the vapor passage 100 congregates toward the wick structure 2 faster, so the working fluid can be congregated to flow back to the evaporating section of the heat pipe (i.e., the heated portion). And the liquid working fluid in the evaporating section flows from the wick structure 2 to the grooves 10, so the evaporating area can be enlarged to reduce thermal resistance of evaporation. The grooves 10 can prevent forming liquid drops which impede the vapor passage. This can further reduce thermal resistance in the vapor passage. The thermal resistance in the evaporating section, condensing section and vapor passage can also be reduced.

Thus, by the abovementioned structure, the radial backflow wick structure of slim-type heat pipe and manufacturing method for the same of the invention can be obtained.

As a result, because the depth of the groove 10 is less than 0.03 mm, usually less than 30% of thickness of a wall of the tube 1, the grooves 10 are very fine and thin and do not affect the vapor passage 100. Also, the grooves 10 radially surround the tube 1 wall, so they can provide a radial backflow effect to the working fluid for flowing back to the wick structure 2. The wick structure 2 can provide an axial backflow effect. The grooves 10 can prevent liquid drops which impede the vapor passage from forming. Thus, the grooves 101 can enhance the wick structure 2 and associate with the wick structure 2 to form a wick network which completely covers the tube 1 wall.

It will be appreciated by persons skilled in the art that the above embodiment has been described by way of example only and not in any limitative sense, and that various alterations and modifications are possible without departure from the scope of the invention as defined by the appended claims.

What is claimed is:

1. A radial backflow wick structure of slim-type heat pipe, comprising:
a tube, being hollow and flat; and
a wick structure, longitudinally disposed in the tube, having an attachment side attached on a local portion of an inner side of the tube and a formation side opposite to the attachment side, wherein the wick structure is superposed on the grooves, and a vapor passage formed between the formation side and the inner side of the tube;
wherein the wick structure is provided with grooves radially around the inner side of the tube, the attachment side is attached on the grooves, and depth of the groove is less than 30% of thickness of a wall of the tube.

2. The radial backflow wick structure of slim-type heat pipe of claim 1, wherein outside thickness of the tube is less than 0.6 mm.

3. The radial backflow wick structure of slim-type heat pipe of claim 1, wherein the grooves are concentric or spiral.

4. The radial backflow wick structure of slim-type heat pipe of claim 1, wherein the grooves are completely or partially formed on the inner side of the tube.

5. The radial backflow wick structure of slim-type heat pipe of claim 1, wherein a depth of the groove is less than 0.03 mm.

6. The radial backflow wick structure of slim-type heat pipe of claim 1, wherein the wick structure is fiber, knitting, powder or combination thereof.

7. A method for manufacturing a slim-type heat pipe, comprising the steps of:
a) preparing a tube with radial grooves around an inner side thereof;
b) providing a flat wick structure with an attachment side being capable of attaching on a local portion of the inner side of the tube and a formation side opposite to the attachment side;
c) placing the wick structure into the tube to attach the attachment side on the local portion of the inner side of the tube, wherein the wick structure is superposed on the grooves; and
d) flattening the tube to make the inner side of the tube abut against the formation side and to form a vapor passage between the formation side and the inner side of the tube.

8. The method of claim 7, wherein the grooves in the step a) are completely or partially formed on the inner side of the tube.

9. The method of claim 7, wherein the grooves are formed by surface processing by a tool, surface corrosion or surface etching.

10. The method of claim 9, wherein the tool is a knife for pressing or cutting the inner side of the tube.

11. The method of claim 9, wherein the tool is a grinding surface formed by a roller, grinding wheel or sandpaper for cutting the inner side of the tube.

12. The method of claim 7, wherein the wick structure is made by sintering, pressing or weaving.

13. The method of claim 7, wherein the wick structure in the step c) is attached on the inner side of the tube by sintering.

14. The method of claim 7, wherein the wick structure in the step c) is positioned by a tool.

15. The method of claim 14, wherein the tool is a rod which can be inserted into the tube and has an aim surface corresponding to the formation side of the wick structure and an abutting portion which is opposite to the aim surface and abuts against the inner side of the tube.

16. The method of claim 15, wherein when the tool has been placed in the tube, a gap between the tube the tool is remained.
